(19) United States
(12) Patent Application Publication
(10) Pub. No.: US 2007/0216262 A1
(43) Pub. Date: Sep. 20, 2007

(54) Polymer Actuator And Its Production Method

(76) Inventors: Tatsuya Hattori, Saitama-ken (JP); Pu Qian, Saitama-ken (JP)

Correspondence Address: LAHIVE & COCKFIELD, LLP, ONE POST OFFICE SQUARE, BOSTON, MA, 02109-2127, US

(21) Appl. No.: 11/578,188

(22) PCT Filed: Apr. 5, 2005
(86) PCT No.: PCT/JP05/06686

§ 371 Date: Oct. 10, 2006

(30) Foreign Application Priority Data
Apr. 9, 2004 (JP) 2004-116073

(51) Int. Cl. H02N 11/00

(52) U.S. Cl. 310/365; 29/592.1

(57) ABSTRACT

A polymer actuator comprising a conductive composite 2 comprising a conductive polymer layer 2b and an extendable substrate 2a, an ion donor 7, work electrodes 5a, 5b, and a counter electrode 6; (a) the conductive composite 2 being formed by impregnating the extendable substrate 2a with one of a conductive-polymer-forming monomer and an oxidation polymerization catalyst and then with the other to polymerize the monomer, and (b) the conductive composite 2 being contractible and/or expandable by voltage applied between the work electrodes 5a, 5b and the counter electrode 6, and its production method.

### FIELD OF THE INVENTION

The present invention relates to a polymer actuator exhibiting large displacement and power and excellent response, and its production method.

### BACKGROUND OF THE INVENTION

In the fields using electromagnetic motors such as robots, cutting machines, automobiles, etc., demand has been mounting to reduce the weight of driving systems. However, because the power densities of the electromagnetic motors depend on the weight of motors, the weight reduction of actuators utilizing the electromagnetic motors is limited. It has been thus desired to develop actuators having different mechanisms from those of the electromagnetic motors, which can generate large power even with reduced size and weight.

As small-sized, lightweight actuators, attention has recently been paid to polymer actuators such as gel actuators using a conductive polymer gel, polymer membrane actuators using a conductive polymer membrane, etc. An example of the conductive polymer membrane actuators comprises a conductive polymer membrane and metal electrodes bonded to a surface of the membrane. The metal electrodes are formed on the conductive polymer membrane by such methods as chemical plating, electroplating, vapor deposition, sputtering, coating, pressure bonding, welding, etc. When potential difference is provided to an assembly of a conductive polymer membrane and metal plate electrodes in a water-containing state, bending and deformation occur in the conductive polymer membrane. Because the bending and deformation of the conductive polymer membrane lead to the bending and deformation of the metal plate electrodes bonded to the conductive polymer membrane, the movement of the entire assembly can be utilized as a driving force.

However, the metal plate electrodes, which are not extendable, prevent the conductive polymer membrane from extending and/or contracting so that the assembly cannot deform enough. Namely, because the deformation of the conductive polymer membrane cannot sufficiently be converted to the deformation of the assembly, the deformation of the conductive polymer membrane cannot efficiently be utilized for the displacement of the actuator. Further, the conductive polymer membrane tends to peel from the metal plate electrode during repeated operation under a repulsion force of the metal plate electrode, providing the actuator with a reduced response speed.

JP2003-152234A discloses an actuator comprising an electrolyte between pluralities of electrodes for causing deformation by applying voltage between the electrodes, each electrode comprising a conductive polymer, and a conductor in electric contact with the conductive polymer, the conductor being in the form of powder, a net or a porous body. This actuator comprises a conductor layer, and a pair of conductive polymer membranes sandwiching the conductor layer, such that the conductor layer and the conductive polymer membranes are curved by the supply of electric current. The conductive polymer layer can be formed on the conductor by electrolytic polymerization. JP2003-152234A describes that because the conductor in the form of powder, a net or a porous body easily follows the movement of the conductive polymer substantially without hindering the contraction of the conductive polymer, the actuator can reach the maximum displacement quickly. However, because this actuator is curved for displacement, it is difficult to control the distance and position of displacement.

Susumu Hara, et al., “polypyrrole-metal coil composite for artificial muscle,” Chemistry Letters, 2003, Vol. 32, No. 9, pp. 800-801 describe artificial muscle constituted by a polypyrrole-metal composite, which is obtained by supplying electric current to a tungsten coil electrode in a pyrrole solution so that polypyrrole is precipitated on the coil surface by electrolytic polymerization. This reference describes that the tungsten-coil-containing composite has large conductivity and power. However, when voltage is applied to the polypyrrole-metal composite for displacement in a state where the composite is immersed in an ion-supplying solution such as an electrolyte solution, etc., tungsten is dissolved away. In addition, because the substrate such as a coil, etc. should act as an electrode, it should have large conductivity. Accordingly, there are many substrates that cannot be used despite large extendibility, resulting in extremely large limitations.

Further, the production of the conductive polymer membrane by electrolytic polymerization as in JP2003-152234A and Chemistry Letters, Vol. 32, No. 9 takes much time, resulting in a high cost.

### OBJECTS OF THE INVENTION

Accordingly, an object of the present invention is to provide a polymer actuator comprising a driver constituted by a conductive polymer and an extendable substrate, which suffers little restriction in selecting the extendable substrate, and can be mass-produced at a low cost.

Another object of the present invention is to provide a method for producing a polymer actuator comprising a driver constituted by a conductive polymer and an extendable substrate, with little restriction in selecting the extendable substrate, and with mass-producibility at a low cost.

### DISCLOSURE OF THE INVENTION

As a result of intense research in view of the above object, the inventors have found that a conductive composite constituted by an extendable substrate of fibers, cloth, etc. and a conductive polymer layer has both softness and strength, and generates large displacement and power with excellent response when used as a driver for an actuator, and that such conductive composite is obtained by impregnating the extendable substrate with one of a conductive-polymer-forming monomer and an oxidation polymerization catalyst and then bringing the other into contact with the substrate. The present invention has been completed based on these findings.

Thus, the first polymer actuator of the present invention comprises a conductive composite comprising a conductive polymer layer and an extendable substrate, an ion donor, a work electrode and a counter electrode; (a) the conductive composite being formed by polymerizing a monomer of the conductive polymer impregnating the extendable substrate in a solution containing an oxidation polymerization catalyst; and (b) the conductive composite being contractible and/or expandable by voltage applied between the work electrode and the counter electrode.

The second polymer actuator of the present invention comprises a conductive composite comprising a conductive polymer layer and an extendable substrate, an ion donor, a work electrode and a counter electrode; (a) the conductive composite being formed by bringing a monomer of the conductive polymer into contact with an oxidation polymerization catalyst carried by the extendable substrate; and (b) the conductive composite being contractible or expandable by voltage applied between the work electrode and the counter electrode.

The conductive composite preferably contains a dopant. The conductive polymer preferably has a conjugated structure, more preferably being at least one selected from the group consisting of polypyrrole, polythiophene, polyaniline, polyacetylene and their derivatives. The ion donor is preferably in the form of a solution, a sol, a gel or their combinations.

The conductive composite preferably contains a conductor other than the conductive polymer. The conductor is preferably in at least one form selected from the group consisting of powder, fibers, nets, and porous plates. The conductor is preferably at least one selected from the group consisting of platinum, gold, palladium, nickel and carbon.

In the polymer actuators according to a preferred embodiment of the present invention, the work electrode is in contact with the conductive composite, and the counter electrode is immersed in the ion donor.

The first method of the present invention for producing a polymer actuator comprises the steps of impregnating an extendable substrate with a monomer of a conductive polymer, immersing the resultant monomer-impregnated substrate in a solution containing an oxidation polymerization catalyst, so that the monomer is polymerized to form a conductive composite, and disposing a work electrode and a counter electrode in an ion donor such that electric current can pass through the conductive composite in the ion donor.

The second method of the present invention for producing a polymer actuator comprises the steps of having an extendable substrate carry an oxidation polymerization catalyst, bringing the resultant oxidation-polymerization-catalyst-carrying substrate into contact with a monomer of a conductive polymer, so that the monomer is polymerized to form a conductive composite, and disposing a work electrode and a counter electrode in an ion donor such that electric current can pass through the conductive composite in the ion donor

Before the polymerization of the monomer, the extendable substrate is preferably impregnated with a dopant. It is also preferable to polymerize the monomer in a state where a conductor other than the conductive polymer is attached to the extendable substrate.

### BRIEF DESCRIPTION OF THE DRAWINGS

FIG. 1 is a vertical cross-sectional view showing one example of the polymer actuators of the present invention.

FIG. 2 is a cross-sectional view showing the displacement of the polymer actuator.

FIG. 3 is a schematic view showing an apparatus for measuring the extension/contraction of the polymer actuator.

FIG. 4 is a schematic view showing an apparatus for measuring power generated by the polymer actuator.

FIG. 5 is a scanning electron photomicrograph showing a surface of the polypyrrole-JK Wiper composite.

FIG. 6 is a graph showing the tensile stress and elongation of the JK Wiper® and the polypyrrole-JK Wiper® composite.

FIG. 7 is a graph showing the relation between electric current and an extension/contraction ratio and applied voltage in the actuator of Example 1.

FIG. 8 is another graph showing the relation between electric current and an extension/contraction ratio and applied voltage in the actuator of Example 1.

FIG. 9 is a further graph showing the relation between electric current and an extension/contraction ratio and applied voltage in the actuator of Example 1.

FIG. 10 is a still further graph showing the relation between electric current and an extension/contraction ratio and applied voltage in the actuator of Example 1.

### DESCRIPTION OF THE PREFERRED EMBODIMENTS

[1] Polymer actuator

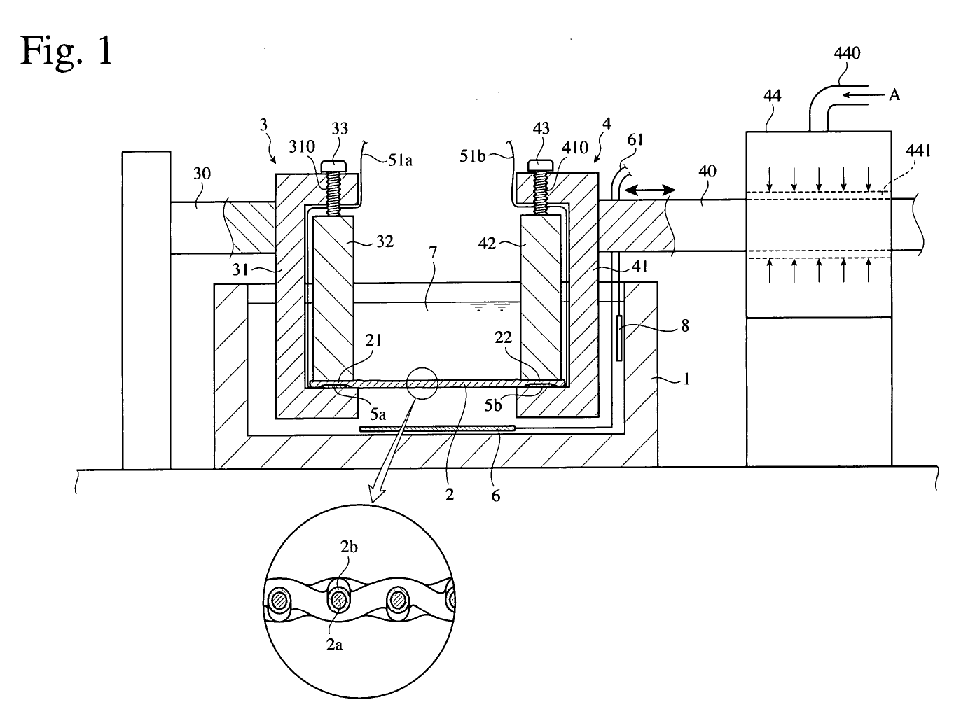

FIG. 1 shows one example of the polymer actuators of the present invention. The polymer actuator shown in FIG. 1 comprises a box-shaped cell 1, a conductive composite 2 horizontally extending in the cell 1 at a position where it is not in contact with the cell 1, a support 3 holding one end 21 of the conductive composite 2, a support 4 holding the other end 22 of the conductive composite 2, work electrodes 5a, 5b in close contact with the ends 21, 22, a counter electrode 6 extending in parallel with the conductive composite 2, and an ion donor 7 contained in the cell 1, in which the counter electrode 6 and the conductive composite 2 are immersed. Because the support rod 30 is stationary, the end of the conductive composite 2 held by the support 3 constitutes a stationary end 21. Because the support rod 40 is movably supported, the end of the conductive composite 2 held by the support 3 constitutes a driving end 22.

As shown in a partial enlarged view in FIG. 1, the conductive composite 2 comprises an extendable substrate 2a, and a conductive polymer layer 2b covering the extendable substrate 2a. Although the conductive polymer layer 2b covers the entire surface of the extendable substrate 2a in the example shown in FIG. 1, the conductive polymer layer 2b need only cover the conductive composite 2 to such an extent that electric current can pass. Accordingly, the conductive polymer layer 2a need not cover the entire surface of the extendable substrate 2a, but may cover 20% or more of the surface area of the extendable substrate 2a.

The thickness of the conductive composite 2 is preferably 0.01-10 mm. When the thickness is less than 0.01 mm, the handling of the conductive composite 2 is difficult. When the thickness is more than 10 mm, it takes undesirably too much time for the conductive polymer layer 2a in the conductive composite 2 to absorb or discharge an electrolyte, etc. into or from the ion donor 7, so that the polymer actuator cannot exhibit good response.

The extendable substrate 2a should be sufficiently extendable to follow the movement of the conductive polymer layer 2b. Specifically, it preferably has an extension/contraction ratio of about 0.01-300%. When the extension/contraction ratio is less than 0.01%, the polymer actuator exhibits too small displacement. Because the extension/contraction ratio of the conductive composite 2 is substantially 300% or less in view of the extension/contraction ratio of the conductive polymer layer 2b, the upper limit of the extension/contraction ratio of the extendable substrate 2a may be about 300%. The extendable substrate 2a is preferably conductive. The conductive composite 2 comprising the conductive, extendable substrate 2a preferably exhibits excellent response. The conductive, extendable substrate 2a may be a woven or nonwoven fabric of platinum wires, gold wires, carbon fibers, etc.

The extendable substrate 2a is preferably porous. When a monomer impregnating the porous extendable substrate 2a is polymerized, a conductive composite 2 having a large surface area can be obtained. The conductive composite 2 having a large surface area is in contact with the ion donor 7 in a large area, so that it can quickly absorb and/or discharge the ion donor 7, exhibiting excellent response.

The extendable substrate 2a may be made of a single material or pluralities of materials. It may also be a single-layer body or a laminate. For instance, the extendable substrate 2a made of a large-conductivity material and a large-elasticity or toughness material shows properties preferable for the conductive composite 2 of the polymer actuator. Preferred examples of the extendable substrate 2a include woven or nonwoven fabrics and foams. The woven or nonwoven fabric is substantially porous, having a large surface area. Usable as the woven or nonwoven fabric are natural fibers such as pulp, cotton, etc., and synthetic fibers such as rayon, acetate, polyesters, polyethylene, polypropylene, polyurethane, nylon, acrylics, etc. The foams may be made of rubbers, polyurethanes, polyvinyl chloride, polyesters, etc. Specific examples of the extendable substrate 2a include Kimwipe®, JK Wiper®, absorbent cotton, etc.

The conductive polymer layer 2a is preferably made of a conductive polymer having a conjugated structure. The conductive polymer having a conjugated structure is more preferably at least one selected from the group consisting of polypyrrole, polythiophene, polyaniline, polyacetylene and their derivatives, particularly polypyrrole. The conductive polypyrrole composite 2 largely extends or contracts by the supply of electric current.

The mass ratio of the conductive polymer layer 2a to the conductive composite 2 is preferably 0.01-10000, more preferably 0.1-1000. When the mass ratio is less than 0.01, too small amounts of an electrolyte and water are absorbed and discharged by the conductive polymer layer 2b, resulting in too small displacement of the polymer actuator. When the mass ratio is more than 10000, the conductive composite 2 has too small conductivity.

Each support 3, 4 comprises a horizontal support rod 30, 40, a U-shaped body member 31, 41 perpendicularly mounted to the support rod 30, 40, and a columnar push member 32, 42 disposed inside the body member 31, 41. A screw 33,43 engages a threaded hole 310,410 in the upper portion of the body member 31, 41, with each end of the conductive composite 2 sandwiched by the inner surface of the body member 31, 41 and the lower end of the push member 32, 42. Because the screws 33, 43 push the upper ends of the push members 32, 42, the conductive composite 2 is sandwiched by the supports 3 and 4. The body members 31, 41 and the push members 32, 42 immersed in the ion donor 7 are insulators.

An air bearing 44 horizontally and movably supports the support rod 40. The air bearing 44 comprises an inlet pipe 440 for the air A. The air A is supplied from the inlet pipe 440 to a gap 441 between the air bearing 44 and the support rod 40. With the air A in the gap 441, the air bearing 44 supports the support rod 40 with substantially no contact, so that the support rod 40 receives substantially no kinetic friction. With the conductive composite 2 extending or contracting by the supply of electric current, the support rod 40 is displaced. Accordingly, one end of the support rod 40 acts as a driving part of the actuator.

The work electrode 5a adhered to the stationary end 21 of the conductive composite 2 is sandwiched by the body member 31 of the stationary support 3 and the conductive composite 2. The work electrode 5b adhered to the driving end 22 of the conductive composite 2 is sandwiched by the body member 41 and the conductive composite 2. As a result, each work electrode 5a, 5b is covered by the conductive composite 2 and the insulating body member 31, 41, without contact with the ion donor 7. Accordingly, when voltage is applied, electric current passes through the conductive composite 2 without leaking to the ion donor 7 and the supports 3, 4.

The work electrodes 5a, 5b and the counter electrode 6 are connected to leads 51a, 51b, 61, respectively. The work electrodes 5a, 5b and the counter electrode 6 are made of platinum, gold, silver, copper, nickel, stainless steel or carbon. The electrode is generally as thick as about 0.1 μm to about 10 mm.

The ion donor 7 contains an electrolyte, which may be sodium chloride, NaPF₆, sodium p-toluene sulfonate and sodium perchlorate, etc. The ion donor 7 may contain, in addition to the electrolyte, a conductive or nonconductive polymer, etc. The conductive polymer contained may be the same as or different from that in the conductive composite 2. The conductive or nonconductive polymer, etc. contained in the ion donor 7 can adjust the fluidity of the ion donor 7. The ion donor 7 should have such fluidity that does not hinder the extension and contraction of the conductive composite 2. The ion donor 7 is preferably in the form of a solution, a sol, a gel, a mixture of a solution and a sol, a mixture of a sol and a gel, a mixture of a solution and a sol, or a mixture of a solution, a sol and a gel. The ion donor 7 is preferably a sol, a gel or their mixture because of no leakage. A solvent and/or a dispersing medium for the ion donor 7 is preferably water. When water is used as a solvent and/or a dispersing medium, the ion donor 7 shows large conductivity. The concentration of an aqueous electrolyte solution is preferably about 0.01-5 mol/L.

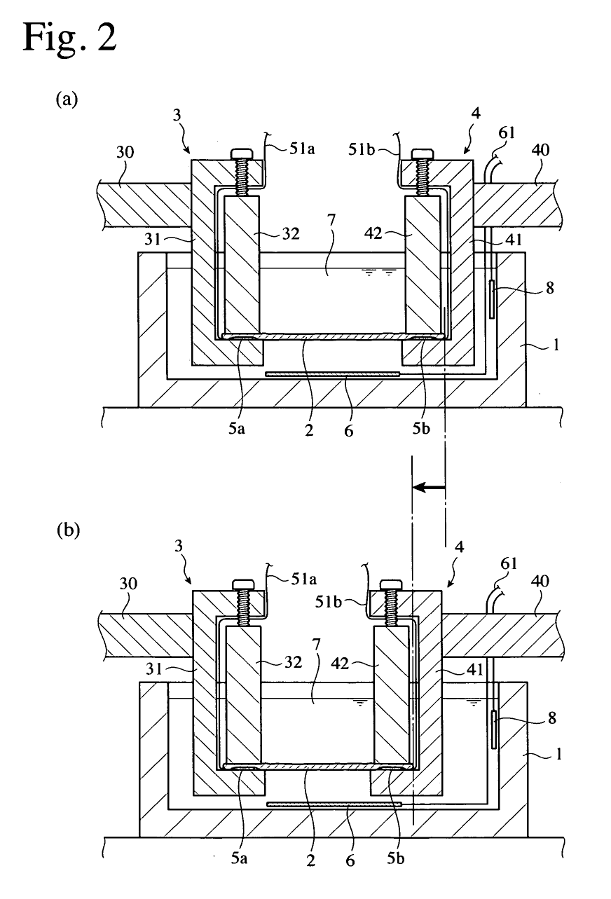

When electric current is supplied between the work electrodes 5a, 5b and the counter electrode 6, the conductive composite 2 extends or contracts to drive the support 4. With such a connection that the work electrodes 5a, 5b act as cathodes at the position shown in FIG. 2(a), when no electric current is supplied, electric current supplied causes the conductive composite 2 to contract, so that the movable support rod 40 moves leftward in the figure [FIG. 2(b)].

When electric current is stopped, the conductive composite 2 recovers its original length, so that the movable support rod 40 moves rightward in the FIG. to the original position [FIG. 2(a)]. How the conductive composite 2 contracts may vary depending on the types of the conductive polymer forming the conductive polymer layer 2a and the ion donor 7. Namely, the conductive composite 2 may contract depending on the types of the conductive polymer and the ion donor 7, when electric current is supplied such that the work electrodes 5a, 5b become cathodes.

It is considered that the conductive polymer layer 2a in the conductive composite 2 absorbs an electrolyte, etc. and its solvent and/or dispersing medium from the ion donor 7 when oxidized by the supply of electric current, and discharge them to the ion donor 7 when reduced, thereby causing the extension/contraction of the conductive composite 2. Because the conductive composite 2 has a large surface area, it can efficiently absorb and/or discharge the ion donor 7. Thus, the polymer actuator of the present invention comprising the conductive composite 2 exhibits excellent response.

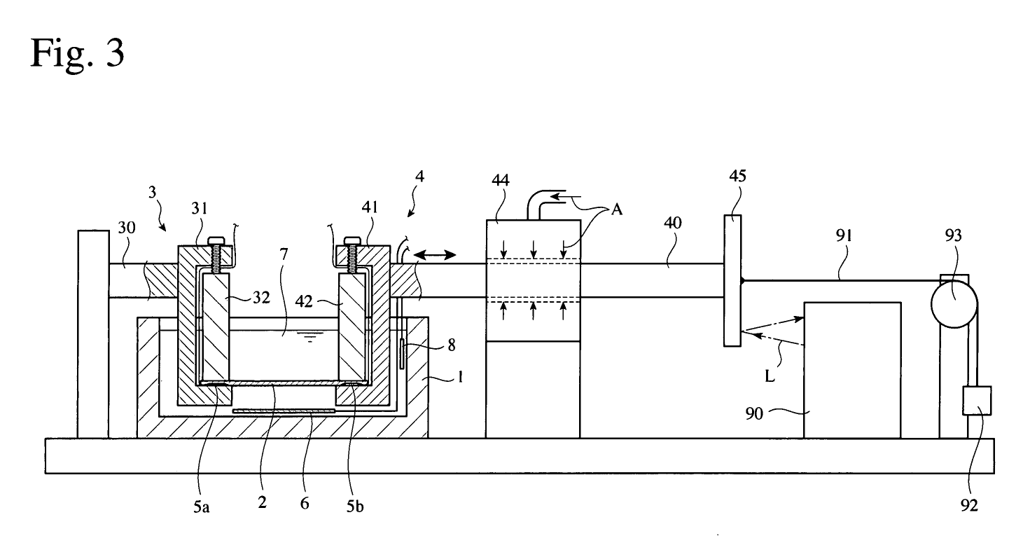

FIG. 3 shows one example of apparatuses for measuring the displacement of the polymer actuator. The polymer actuator comprises a measuring plate 45 perpendicularly mounted to a tip end of the movable support rod 40. Disposed near the measuring plate 45 is a laser displacement meter 90. A reference electrode 8 is immersed in the ion donor 7 in the cell 1 to observe the change of electric current by applied voltage. A weight 92 connected to the measuring plate 45 via a string 91 suspends from a pulley 93 to pull the conductive composite 2. Because the conductive composite 2 contracts against the weight 92, the displacement of the conductive composite 2 can be measured while applying a load thereto.

In a state where the weight 92 suspends from the pulley 93, voltage is applied such that the work electrode 5a, 5b becomes a cathode or an anode.

When sufficiently large voltage is applied, the energized conductive composite 2 contracts against the weight 92, thereby displacing the movable support rod 40 leftward in the figure (toward the cell 1). Thus, the measuring plate 45 mounted to the tip end of the movable support rod 40 is also displaced by the same distance. Because the laser displacement meter 90 is positioned such that a laser light L always reaches the measuring plate 45 effectively at any displacement by the supply of electric current, the laser displacement meter 90 can measure the displacement of the polymer actuator.

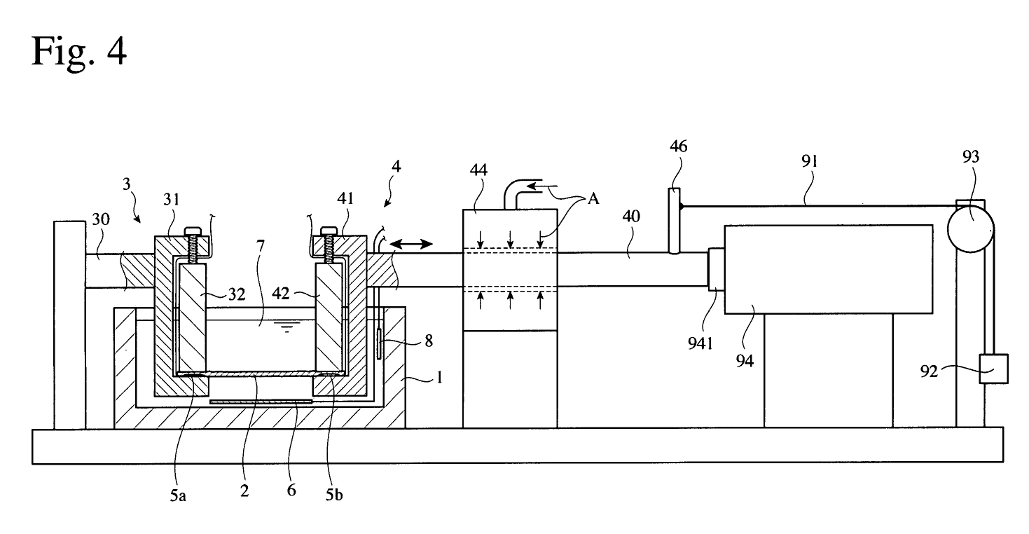

FIG. 4 shows one example of apparatuses for measuring power generated by the polymer actuator. Because the apparatus shown in FIG. 4 is the same as shown in FIG. 3 except that a load cell 94 is connected to a tip end of the movable support rod 40, only differences will be explained below. A member 46 for supporting a weight 92 is perpendicularly mounted to the movable support rod 40, and the support member 46 is connected to one end of a string 91. The string 91 is horizontally supported by the support member 46 and a pulley 93 to pull the movable support rod 40 rightward in the figure. Accordingly, the movable support rod 40 slightly pushes a load cell 94.

Because a strain-detecting plate (not shown) in the load cell 94 is connected to a load button 941, the contraction of the conductive composite 2 reduces a force of pushing the load button 941, resulting in decrease in strain in the detecting plate and thus enabling the measurement of its load. A load can of course be measured when the conductive composite 2 extends to increase a force of pushing the load button 941.

In a state where the weight 92 suspends from the pulley 93, voltage is applied such that the work electrode 5a, 5b becomes a cathode or an anode. Sufficiently large voltage energizes the conductive composite 2 to generate a contracting force. With a sufficiently large weight 92, the contracting force of the conductive composite 2 reduces a force of pushing the load button 941, although the movable support rod 40 is not substantially displaced. This reduction of load is regarded as a force generated by the contraction of the conductive composite 2.

The generated force can also be measured in a state where there is no weight 92 suspending (the weight 92 was 0 g). With no or sufficiently small weight 92, the movable support rod 40 pulled by the conductive composite 2 is displaced according to the contraction of the conductive composite 2 by the supply of electric current. The force of the movable support rod 40 pulling the load button 941 is thus measured.

[2] Production method of polymer actuator

(1) Production of conductive composite

The conductive composite can be produced by (i) a method of bringing a conductive-polymer-forming monomer impregnating an extendable substrate 2a into contact with an oxidation polymerization catalyst, or (ii) a method of bringing the monomer into contact with the oxidation polymerization catalyst carried by the extendable substrate 2a.

(i) First Production Method

The impregnation of the conductive-polymer-forming monomer may be conducted by (a) immersing the extendable substrate 2a in the conductive-polymer-forming monomer and/or its solution, (b) spraying the conductive-polymer-forming monomer and/or its solution to the extendable substrate 2a, or (c) evaporating the conductive-polymer-forming monomer such that it comes into contact with the extendable substrate 2a. The monomer solution preferably has a concentration of 0.001 mol/L or more. When the concentration is less than 0.001 mol/L, the substrate cannot be impregnated with a sufficient amount of the monomer.

The amount of the impregnating monomer can be properly determined depending on the type of the extendable substrate 2a, etc. For instance, when a pulp sheet having a thickness of 100-200 μm is used as the extendable substrate 2a, the amount of the monomer consumed in one impregnating operation is about 0.01-0.5 mg/mm².

The conductive composite 2 may contain at least one conductor selected from the group consisting of metals, metal salts and carbon, to improve its conductivity. The production of the conductive composite containing a conductor other than the conductive polymer may be carried out by (a) a method of impregnating the extendable substrate with a mixture of the conductor and the monomer of the conductive polymer, or (b) a method of attaching the conductor to the extendable substrate and impregnating the substrate with the monomer. The preferred metals include iron, copper, nickel, titanium, zinc, chromium, aluminum, cobalt, gold, platinum, silver, manganese, tungsten, palladium, ruthenium and zirconium. Examples of the metal salts include iron dichloride, copper chloride.

The monomer-impregnated substrate is placed in a solution of the oxidation polymerization catalyst to cause the polymerization reaction of the monomer. The oxidation polymerization catalyst is not particularly restricted, and general catalysts for the oxidation polymerization of the conductive polymer may be used. The preferred oxidation polymerization catalyst may be iron trichloride or hydrogen peroxide. The molar ratio of the catalyst to the impregnating monomer in the solution is preferably 0.1-10,000. When the molar ratio of the catalyst to the impregnating monomer is less than 0. 1, the polymerization reaction is too slow. Even when the molar ratio exceeds 10,000, no further improvement in the reaction speed and the conductivity of the conductive composite 2 cannot be obtained. To achieve this molar ratio range, the concentration of the oxidation polymerization catalyst in the solution is preferably about 0.0001-5 M. During the reaction, a solution temperature is preferably −78° C. to 40° C., more preferably 0° C. or lower. When the reaction temperature is higher than 40° C., it is difficult to obtain the conductive polymer having excellent conductivity. When it is lower than −78° C., the polymerization reaction takes too much time. For instance, when JK Wiper® of 500-1500 mm² is impregnated with 0.1-0.5 g of pyrrole, the polymerization reaction is completed by holding the JK Wiper® in an oxidation catalyst solution at 0° C. for about 10-30 minutes. The preferred solvents include methanol, ethanol, hexane, acetonitrile, propylene carbonate, and water.

(ii) Second Production Method

The oxidation polymerization catalyst can be carried by the extendable substrate 2a by immersion in the oxidation polymerization catalyst solution. The preferred oxidation polymerization catalyst may be the same as used in the first production method. The concentration of the oxidation polymerization catalyst in the solution is preferably 0.0001-5 M. When the concentration of the oxidation polymerization catalyst in the solution is less than 0.0001 M, it is difficult to carry a sufficient amount of the catalyst on the extendable substrate 2a. When the concentration exceeds 5 M, too much catalyst is carried.

When brought into contact with the substrate carrying the oxidation polymerization catalyst, the conductive-polymer-forming monomer is polymerized on a surface of the extendable substrate 2a to form the conductive composite. The contact of the conductive-polymer-forming monomer with the oxidation-polymerization-catalyst-carrying substrate may be carried out by (a) evaporating the monomer in a vessel having the oxidation-polymerization-catalyst-carrying substrate, or (b) spraying a liquid monomer and/or its solution. Taking for example the method (a) of evaporating the monomer in the vessel to bring the monomer into contact with the oxidation-polymerization-catalyst-carrying substrate, the second production method will be explained.

After charging a monomer and a substrate carrying an oxidation polymerization catalyst into a vessel, the vessel is sealed and kept preferably at a temperature of 40° C. or lower. The lower limit of the temperature is preferably −20° C. or higher in the case of using pyrrole, though varying depending on the volatility of the monomer.

Taking for example the conductive composite 2 comprising the conductive polymer layer 2a made of polypyrrole, the second production method will be explained specifically. 1-10 g of pyrrole is charged into a glass vessel having a volume of 100-500 mL and kept at 0-25° C. Pyrrole evaporated in the vessel comes into contact with the oxidation polymerization catalyst on the substrate carrying the oxidation polymerization catalyst to be polymerized to black polypyrrole. After keeping it at room temperature ±2° C. for about 0.5-3 hours, the polymerization reaction is terminated.

(iii) Addition of Dopant

In any production methods, a dopant other than the oxidation polymerization catalyst may be added to a solution containing the oxidation polymerization catalyst. The concentration of the dopant is preferably 0.01-5 M. The monomer is polymerized in such a manner that the oxidation polymerization catalyst and/or the dopant other than the oxidation polymerization catalyst are contained in the resultant polymer. A usual dopant, p-type or n-type, may be used. Examples of the p-type dopants include halogens such as Cl₂, Br₂, I₂, ICl, ICl₃, IBr, IF₃, etc.; Lewis acids such as PF₅, PF₆, BF₄, AsF₅, SbF₅, etc.; transition metal salts such as iron trichloride, titanium tetrachloride, iron sulfate, iron nitrate, iron perchloride, iron phosphate, iron sulfate, iron bromide, iron hydroxide, copper nitrate, copper sulfate, copper chloride, etc.; sulfuric acid, nitric acid, perchloric acid, etc.; and organic acids such as p-toluene sulfonic acid, etc. The transition metal salts such as copper chloride, iron trichloride, etc. act not only as oxidation polymerization catalysts but also as dopants. Examples of the n-type dopants include alkali metals such as Li, Na, K, Rb, Cs, etc.; and alkaline earth metals such as Be, Mg, Ca, Sr, Ba, etc.; and Sc, Ag, Eu, Yb, etc.

Although a composite of the conductive polymer obtained by the polymerization reaction and the extendable substrate 2a may be used as the conductive composite 2 without treatment after washing, an additional conductive-polymer-forming monomer is preferably polymerized after or while impregnating the substrate. The repetition of impregnation and polymerization steps enables the extendable substrate 2a to be impregnated with a desired amount of the monomer. Although variable depending on the type and amount of the impregnating monomer, the number of impregnation and polymerization steps is generally about 2-10 to produce the conductive composite 2 having both conductivity and softness.

(2) Assembling of polymer actuator

A work electrode 5a, 5b is formed on each end portion of the conductive composite 2. The work electrodes 5a, 5b can be formed by chemical plating, electroplating, vapor deposition, sputtering, coating, pressure-bonding, welding, etc. The conductive composite 2 sandwiched by the body members 31, 41 and the push members 32, 42 extends between the supports 3 and 4, and the ion donor 7 is charged into the cell such that the entire conductive composite 2 is immersed in the ion donor 7, to obtain the polymer actuator.

The present invention will be explained in more detail with reference to Examples below without intention of restricting the scope of the present invention.

Example 1

(1) Production of composite of polypyrrole and JK Wiper (first production method)

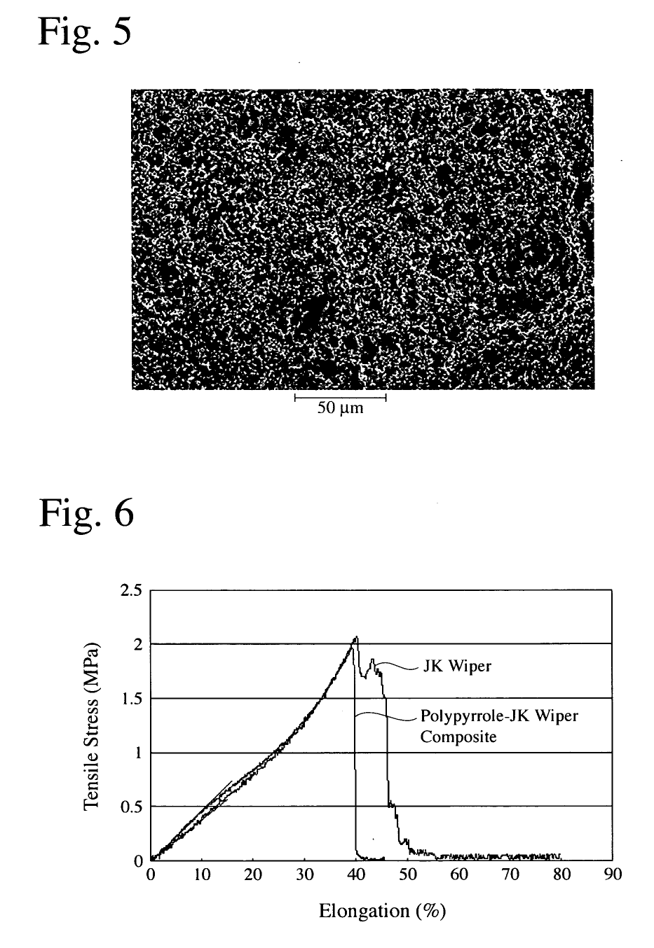

1.43 g of 175 μm-thick JK Wiper® (210×230×1.58 mm³, available from Crecia Co., Ltd.) was cut to 20 mm×50 mm, and impregnated with 0.2 g of pyrrole. The pyrrole-impregnated JK Wiper was immersed in a 2.5-M solution of FeCl₃ in methanol (hereinafter referred to as “FeCl₃-methanol solution”), kept at 0° C. for 1 hour to polymerize pyrrole, and then washed with methanol. It was impregnated with 0.2 g of pyrrole again, and the pyrrole was polymerized in an FeCl₃-methanol solution to obtain a polypyrrole-JK Wiper composite. After washing with methanol, the composite was vacuum-dried at room temperature for 8 hours. This polypyrrole-JK Wiper composite had a thickness of 260 μm and voltage resistance of 30Ω. FIG. 5 is a scanning electron photomicrograph showing a surface of the polypyrrole-JK Wiper composite.

(2) Measurement of Tensile Stress and Elongation

The JK Wiper cut to 15 mm×5 mm and the polypyrrole-JK Wiper composite cut to 17 mm×6 mm were measured with respect to tensile stress and elongation. The results are shown in FIG. 6. The JK Wiper had tensile stress of 2.07 MPa, and the polypyrrole-JK Wiper composite had tensile stress of 1.96 MPa.

(3) Assembling of polymer actuator and measurement of its displacement

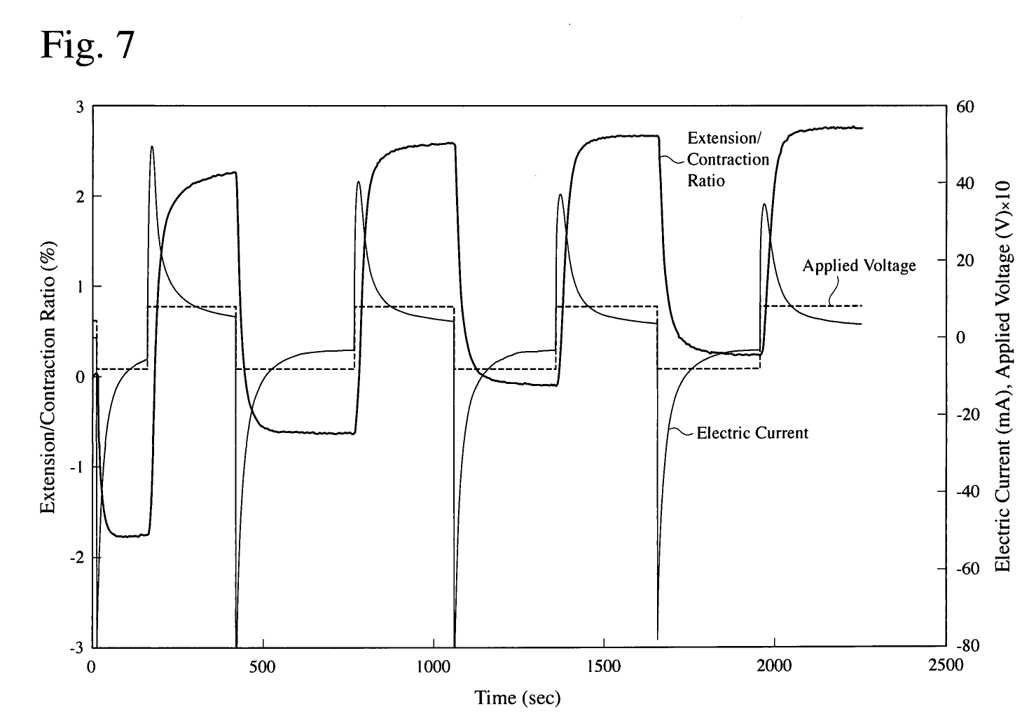

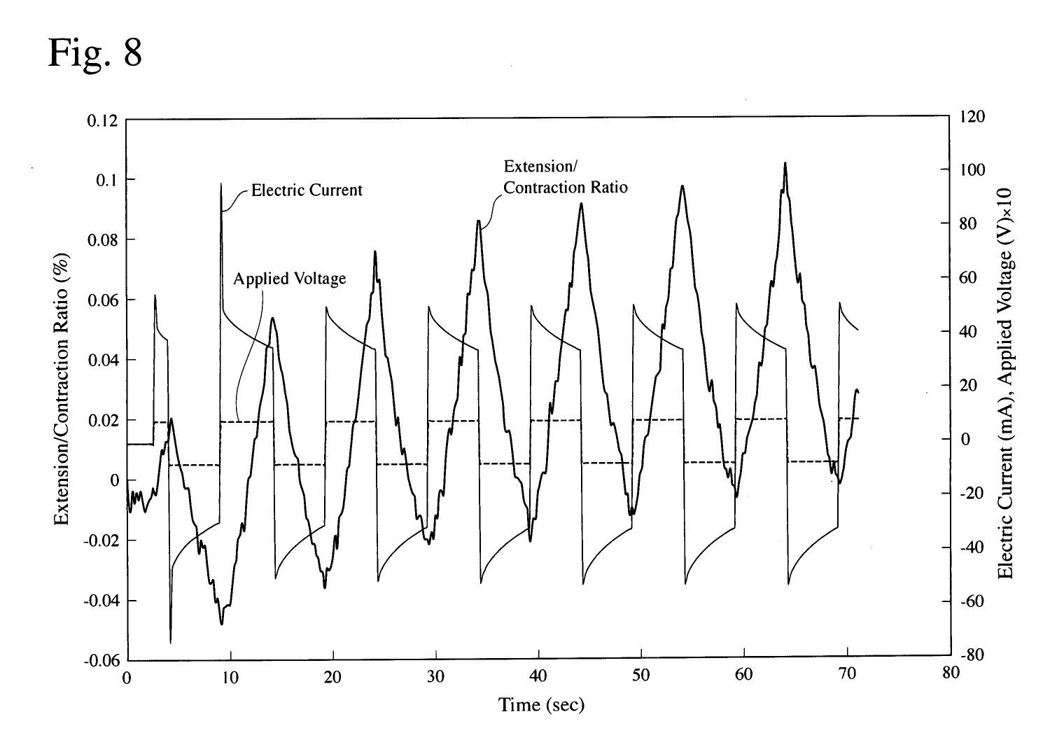

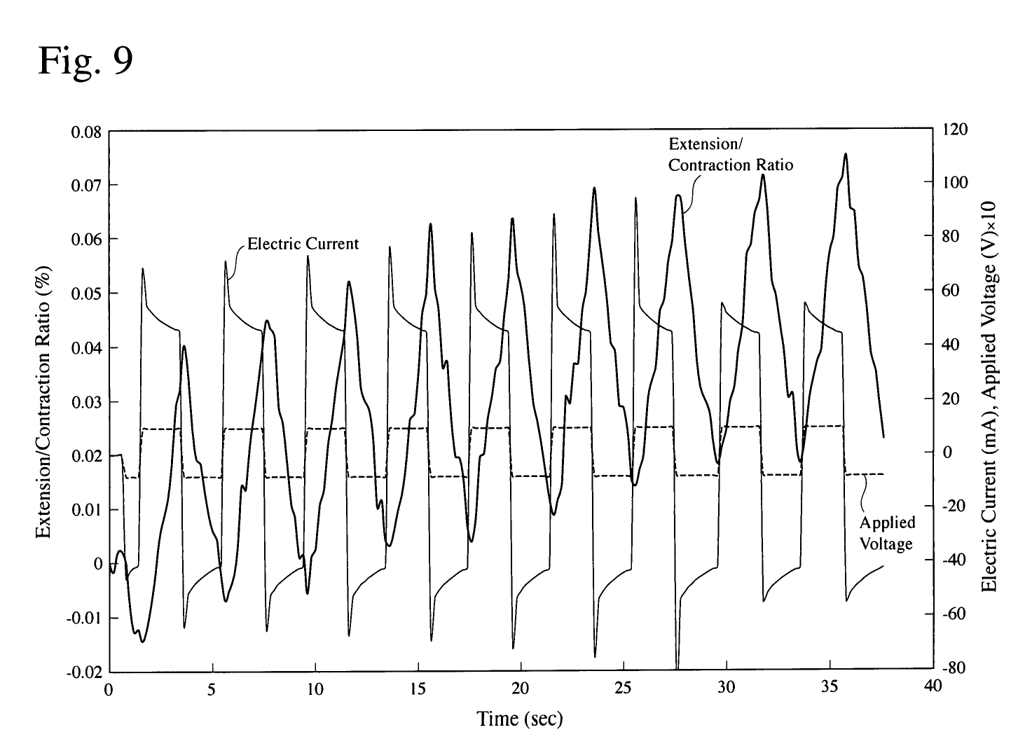

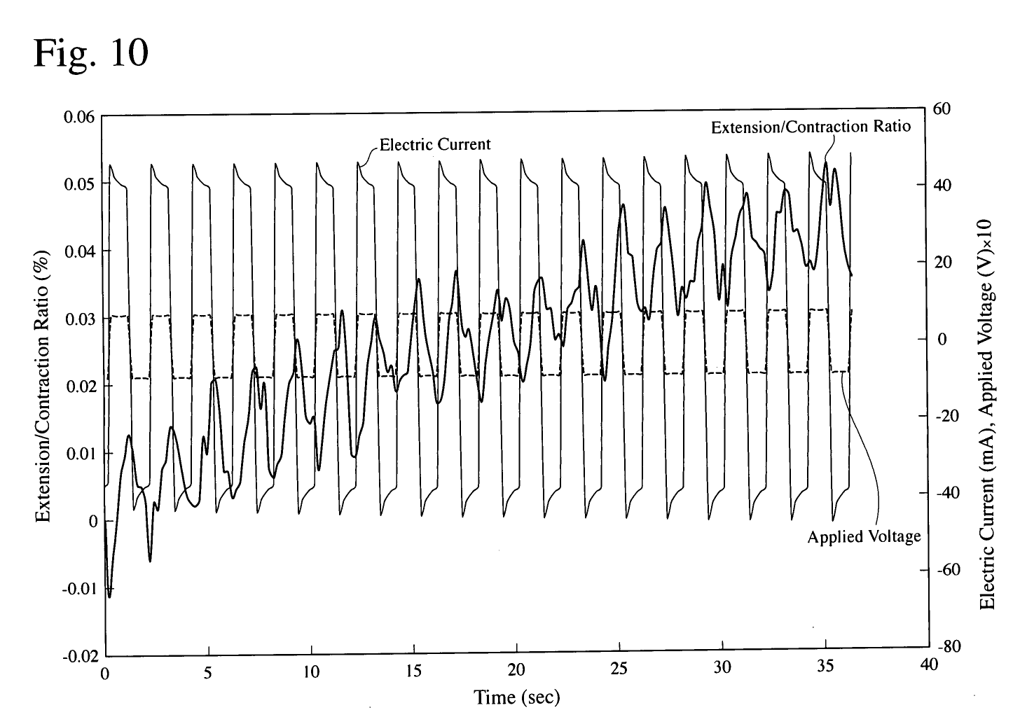

With a platinum foil (thickness: 30 gm) attached to each end of the polypyrrole-JK Wiper composite (8.0 mm×0.5 mm), a polymer actuator shown in FIGS. 1 and 2 was assembled, and placed in the measuring apparatus shown in FIG. 3. With a weight 92 of 10.0 g suspending from a pulley 93, and voltage applied between the work electrodes 5a, 5b and the counter electrode 6, the electric current and the extension/contraction ratio (displacement) were measured. The results are shown in FIG. 7. Also, voltage in a rectangular waveform having a frequency of 0.1 Hz, 0.25 Hz and 0.5 Hz, respectively, was applied to measure the electric current and the extension/contraction ratio (displacement). The results are shown in FIGS. 8-10. In any measurements, other measurement conditions than the frequency were as described below.

The maximum extension/contraction ratio of the polypyrrole-JK Wiper composite (maximum displacement ratio of the polymer actuator) was about 4%.

In any measurements, the polymer actuator exhibited good response.

| | |
|---|---|
| Ion donor | Aqueous solution of NaPF₆ (1 mol/L), |
| Work electrode | Platinum foil, |
| Counter electrode | Platinum foil, |
| Reference electrode | Ag/AgCl, and |
| Applied voltage | −0.8 V to +0.8 V. |

Example 2

(1) Production of Composite of Polypyrrole and JK Wiper (Second Production Method)

1.43 g of 175 μm-thick JK Wiper® (210×230×1.58 mm³, available from Crecia Co., Ltd.) was cut to 20 mm×50 mm, and impregnated with 1 mL of a 2.5-M FeCI₃-methanol solution to obtain an orange-colored FeCl₃-impregnated JK Wiper. 2 mL of pyrrole was charged into a glass vessel (volume: 200 mL), and the glass vessel was sealed by a cap with the FeCl₃-impregnated JK Wiper suspending therein. This glass vessel was kept at room temperature for 1 hour, so that the color of the FeCl₃-impregnated JK Wiper gradually changed from orange to black. The black FeCl₃-impregnated JK Wiper was taken out of the glass vessel, washed with methanol, and then dried at room temperature. It was impregnated with 0.2 g of pyrrole again, and the pyrrole was polymerized in an FeCl₃-methanol solution to obtain a polypyrrole-JK Wiper composite. After washing with methanol, this composite was immersed in an FeCl₃-methanol solution again, and kept in a pyrrole-containing glass vessel. After the resultant polypyrrole-JK Wiper composite was washed with methanol, the composite was vacuum-dried at room temperature for 8 hours. This polypyrrole-JK Wiper composite had a thickness of 300 μm and voltage resistance of 35Ω.

A polymer actuator was assembled in the same manner as in the step (3) of Example 1, except for using the polypyrrole-JK Wiper composite obtained in the step (1) of Example 2. Voltage in a rectangular waveform of −0.8 V and +0.8 V was applied between the work electrodes 5a, 5b and the counter electrode 6 in this polymer actuator to measure the electric current and the extension/contraction ratio (displacement). The maximum extension/contraction ratio of the polypyrrole-JK Wiper composite was about 2.5%.

| | |
|---|---|
| Ion donor | Aqueous solution of NaPF₆ (1 mol/L), |
| Reference electrode | Platinum foil, |
| Counter electrode | Platinum foil, |
| Work electrode | Ag/AgCl, and |
| Applied voltage | −0.8 V to +0.8 V. |

### EFFECT OF THE INVENTION

The polymer actuator of the present invention comprises a conductive composite comprising a conductive polymer layer and an extendable substrate, and electric current can pass through the conductive composite in an ion donor. Electric current causes the conductive polymer in the conductive composite to absorb and/or discharge the ion donor, thereby extending or contracting the conductive composite to drive the polymer actuator. The conductive composite is obtained by polymerizing a conductive-polymer-forming monomer after or while impregnating the extendable substrate. The extendable substrate preferably constituted by fibers, cloth, etc. flexibly follows the movement of the conductive polymer. Accordingly, the polymer actuator comprising the conductive composite can quickly extend and/or contract by the supply of electric current, exhibiting good response.

In the production of the polymer actuator of the present invention, after one of a conductive-polymer-forming monomer and an oxidation polymerization catalyst impregnates or is attached to the extendable substrate, the other is brought into contact with the substrate, so that the monomer is polymerized to form the conductive composite. The conductive composite comprising a nonconductive substrate can be produced by oxidation polymerization by such a method. Thus, wide varieties of substrates can be selected, and a substrate having both excellent extendibility and strength and a large surface area can be used. In addition, the oxidation polymerization method is much less expensive and more suitable for mass production than the electrolytic polymerization method.

1. A polymer actuator comprising a conductive composite comprising a conductive polymer layer and an extendable substrate, an ion donor, a work electrode and a counter electrode; (a) said conductive composite being formed by polymerizing a monomer of said conductive polymer impregnating said extendable substrate in a solution containing an oxidation polymerization catalyst; and (b) said conductive composite being contractible and/or expandable by voltage applied between said work electrode and said counter electrode.

2. A polymer actuator comprising a conductive composite comprising a conductive polymer layer and an extendable substrate, an ion donor, a work electrode and a counter electrode; (a) said conductive composite being formed by bringing a monomer of said conductive polymer into contact with an oxidation polymerization catalyst carried by said extendable substrate; and (b) said conductive composite being contractible and/or expandable by voltage applied between said work electrode and said counter electrode.

3. The polymer actuator according to claim 1, wherein said conductive composite contains a dopant.

4. The polymer actuator according to claim 1, wherein said conductive polymer has a conjugated structure.

5. The polymer actuator according to claim 1, wherein said conductive polymer is at least one selected from the group consisting of polypyrrole, polythiophene, polyaniline, polyacetylene and their derivatives.

6. The polymer actuator according to claim 1, wherein said ion donor is in the form of a solution, a sol, a gel or their combinations.

7. The polymer actuator according to claim 1, wherein said conductive composite contains a conductor other than said conductive polymer.

8. The polymer actuator according to claim 7, wherein said conductor is in at least one form selected from the group consisting of powder, fibers, nets, and porous plates.

9. The polymer actuator according to claim 7, wherein said conductor is at least one selected from the group consisting of platinum, gold, palladium, nickel and carbon.

10. The polymer actuator according to claim 1, wherein said work electrode is in contact with said conductive composite, and said counter electrode is in contact with said ion donor.

11. A method for producing a polymer actuator comprising the steps of impregnating an extendable substrate with a monomer of a conductive polymer, immersing the resultant monomer-impregnated substrate in a solution containing an oxidation polymerization catalyst, so that said monomer is polymerized to form a conductive composite, and disposing a work electrode and a counter electrode in an ion donor such that electric current can pass through the conductive composite in said ion donor.

12. A method for producing a polymer actuator comprising the steps of having an extendable substrate carry an oxidation polymerization catalyst, bringing the resultant oxidation-polymerization-catalyst-carrying substrate into contact with a monomer of a conductive polymer, so that said monomer is polymerized to form a conductive composite, and disposing a work electrode and a counter electrode in an ion donor such that electric current can pass through the conductive composite in said ion donor.

13. The method for producing a polymer actuator according to claim 11, wherein said extendable substrate is impregnated with a dopant.

14. The method for producing a polymer actuator according to claim 11, wherein said monomer is polymerized in a state where a conductor other than said conductive polymer is attached to said extendable substrate.

15. The polymer actuator according to claim 2, wherein said conductive composite contains a dopant.

16. The polymer actuator according to claim 2, wherein said conductive polymer has a conjugated structure.

17. The polymer actuator according to claim 2, wherein said conductive polymer is at least one selected from the group consisting of polypyrrole, polythiophene, polyaniline, polyacetylene and their derivatives.

18. The polymer actuator according to claim 2, wherein said ion donor is in the form of a solution, a sol, a gel or their combinations.

19. The polymer actuator according to claim 2, wherein said conductive composite contains a conductor other than said conductive polymer.

20. The polymer actuator according to claim 19, wherein said conductor is in at least one form selected from the group consisting of powder, fibers, nets, and porous plates.

21. The polymer actuator according to claim 19, wherein said conductor is at least one selected from the group consisting of platinum, gold, palladium, nickel and carbon.

22. The polymer actuator according to claim 2, wherein said work electrode is in contact with said conductive composite, and said counter electrode is in contact with said ion donor.

23. The method for producing a polymer actuator according to claim 12, wherein said extendable substrate is impregnated with a dopant.

24. The method for producing a polymer actuator according to claim 12, wherein said monomer is polymerized in a state where a conductor other than said conductive polymer is attached to said extendable substrate.
